(19) United States
(12) Patent Application Publication
(10) Pub. No.: US 2023/0419081 A1
(43) Pub. Date: Dec. 28, 2023

(54) DETECTING DEVICE, DETECTING METHOD, MACHINE LEARNING DEVICE, MACHINE LEARNING METHOD, AND MACHINE LEARNING MODEL

(71) Applicant: Rakuten Group, Inc., Tokyo (JP)

(72) Inventors: Takashi TOMOOKA, Tokyo (JP); Mitsuru Nakazawa, Tokyo (JP)

(73) Assignee: Rakuten Group, Inc., Tokyo (JP)

(21) Appl. No.: 18/339,641

(22) Filed: Jun. 22, 2023

(30) Foreign Application Priority Data
Jun. 24, 2022 (JP) 2022-101995

(51) Int. Cl. G06N 3/0455; G06N 3/084; G06Q 30/018

(52) U.S. Cl. CPC G06N 3/0455; G06N 3/084; G06Q 30/0185

(57) ABSTRACT

Disclosed herein is a detecting device including a second machine learning model provided for mutual learning together with a first machine learning model, the first machine learning model being subjected to machine learning so as to generate genuine or fraudulent article information having a plurality of modalities, and the second machine learning model being subjected to machine learning so as to discriminate whether article information having a plurality of modalities is genuine or not, an obtaining section configured to obtain article information having a plurality of modalities, and an estimating section configured to estimate whether the article information that is obtained by the obtaining section and has the plurality of modalities is genuine or not, by using the second machine learning model.

### CROSS REFERENCE TO RELATED APPLICATIONS

This non-provisional application claims priority under 35 U.S.C. § 119(a) on Patent Application No. 2022-101995 filed in Japan on Jun. 24, 2022, the entire contents of which are hereby incorporated by reference.

### BACKGROUND

The present disclosure relates to a detecting device, a detecting method, a computer readable medium, a machine learning device, a machine learning method, and a machine learning model.

In recent years, electronic commerce has spread widely. In electronic commerce, a person who wants to purchase an article to be traded does not actually take the article in the hand of the person. Hence, there is a desire for various measures to prevent fraudulent exhibition such as exhibition of ungenuine articles and allow users to use electronic commerce service with security.

An example of the related art is disclosed in Japanese Patent Laid-open No. 2019-101959.

### SUMMARY

In order to meet the above-described desire, a system has conventionally been proposed which detects fraudulent articles in electronic commerce service by using a machine learning model. However, using such a system necessitates preparation of information relating to actual examples of fraudulent articles as machine learning data.

Meanwhile, the fact is that, depending on fields of articles, coupled with the diversification of actual articles being handled and the shortening of periods of trend cycles, the articles are constantly changing. Therefore, it is sometimes difficult to prepare the machine learning data. Such a situation is not limited to the detection of fraudulent articles. A similar situation can occur also in detecting articles in a certain alternative state (hereinafter referred to as a target state), for example, in a distinction between fraudulence and genuineness or a distinction between appropriateness and inappropriateness based on a certain criterion.

The present disclosure has been made in view of the above-described actual situations. It is an object of the present disclosure to provide a technology capable of detecting the target state even under circumstances where it is difficult to prepare data necessary for machine learning.

According to one aspect of the present disclosure, there is provided a detecting device including a second machine learning model provided for mutual learning together with a first machine learning model, the first machine learning model being subjected to machine learning so as to generate genuine or fraudulent article information having a plurality of modalities, and the second machine learning model being subjected to machine learning so as to discriminate whether article information having a plurality of modalities is genuine or not, an obtaining section configured to obtain article information having a plurality of modalities, and an estimating section configured to estimate whether the article information that is obtained by the obtaining section and has the plurality of modalities is genuine or not, by using the second machine learning model.

According to the aspects of the present disclosure, a model that is subjected to machine learning so as to output information for target state detection can be used even under circumstances where it is difficult to prepare data necessary for machine learning.

### BRIEF DESCRIPTION OF THE DRAWINGS

FIG. 1 is a block diagram illustrating a configuration and a connection example of a detecting device according to an embodiment of the present disclosure;

FIG. 2 is a functional block diagram illustrating an example of a machine learning section implemented by the detecting device according to the embodiment of the present disclosure;

FIG. 3 is a functional block diagram illustrating an example of a control unit that performs machine learning processing in the detecting device according to the embodiment of the present disclosure;

FIG. 4 is a functional block diagram illustrating an example of a control unit that performs inference processing in the detecting device according to the embodiment of the present disclosure; and

FIG. 5 is a diagram of assistance in explaining an example of an article page corresponding to article information, the article page being handled by the detecting device according to the embodiment of the present disclosure.

### DETAILED DESCRIPTION OF THE PREFERRED EMBODIMENT

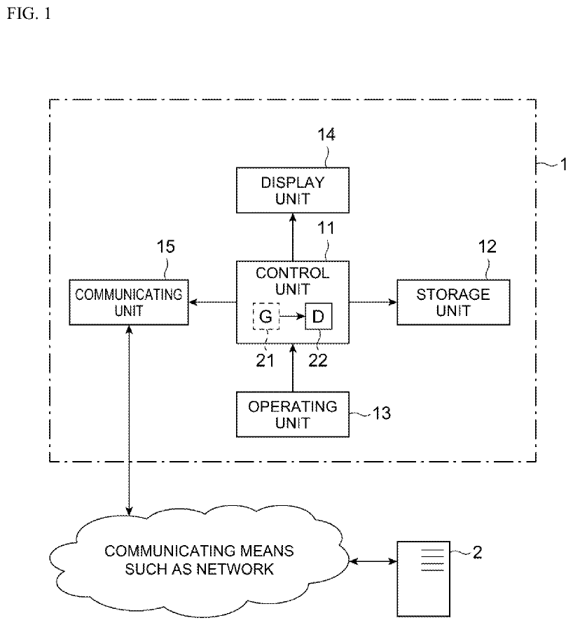

An embodiment of the present disclosure will be described with reference to the drawings. As illustrated in FIG. 1, a detecting device 1 according to the embodiment of the present disclosure includes a control unit 11, a storage unit 12, an operating unit 13, a display unit 14, and a communicating unit 15. In addition, the detecting device 1 may be communicably connected to a server device 2 via a network.

The control unit 11 is a program-controlled device such as a central processing unit (CPU). The control unit 11 operates according to a program stored in the storage unit 12. In an example of the present embodiment, the control unit 11 functionally implements a second machine learning model 22 provided for mutual learning together with a predetermined first machine learning model 21. Here, the first machine learning model 21 is subjected to machine learning so as to generate article information that has a plurality of modalities and is to be recognized as genuine or fraudulent article information (that is, to be recognized as being in a target state). In addition, the second machine learning model 22 is subjected to machine learning so as to discriminate whether or not article information having a plurality of modalities is in a target state (whether the article information is genuine or not, for example), and output the result. This machine learning may be performed in the detecting device 1 or may be performed in another information processing device such as a machine learning device different from the detecting device 1. Incidentally, in the present embodiment, the article information including a plurality of modalities (types of information) will be referred to simply as article information.

In a case where the machine learning of the second machine learning model 22 is performed by the detecting device 1, the control unit 11 functions also as the first machine learning model 21. In addition, in a case where the machine learning of the second machine learning model 22 is performed in another information processing device different from the detecting device 1, the control unit 11 does not necessarily need to function as the first machine learning model 21.

The control unit 11 obtains input of article information to be recognized as being genuine or not, and estimates whether the obtained article information is genuine or not, by using the second machine learning model 22 described above. Then, the control unit 11 outputs a result of the estimation. Detailed contents of the first and second machine learning models 21 and 22 implemented by the control unit 11 and an example of operation of the control unit 11 will be described later.

The storage unit 12 is a memory device, a disk device, or the like. The storage unit 12 stores the program to be executed by the control unit 11, and may store data of parameters of the machine learning models. The program may be a program that is stored and provided on a computer readable and non-transitory recording medium and is copied into the storage unit 12.

The operating unit 13 may include a keyboard, a mouse, or the like. The operating unit 13 receives a user operation and outputs information indicating contents of the operation to the control unit 11. The display unit 14 is a display or the like. The display unit 14 displays an image according to an instruction input from the control unit 11.

The communicating unit 15 is, for example, a network interface. The communicating unit 15 outputs data received via the network to the control unit 11, and sends out data to an external server or the like via the network according to an instruction input from the control unit 11.

[First Machine Learning Model]

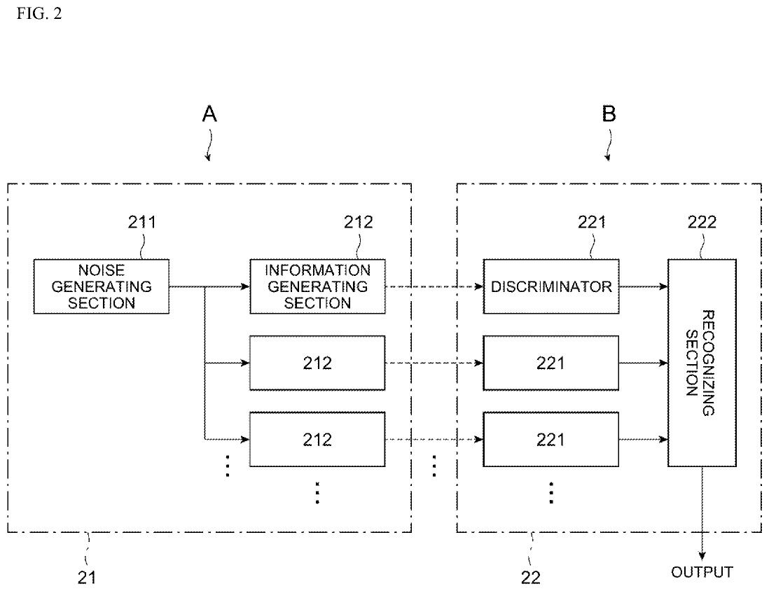

As illustrated in FIG. 2, the first machine learning model 21 according to an example of the present embodiment functionally includes a noise generating section 211 and at least one information generating section 212. Incidentally, machine learning models that generate information regarding respective modalities of article information may collectively be treated as the first machine learning model 21.

The noise generating section 211 is, for example, a random number generator. When there is an instruction to the effect that the information generating section 212 is to be caused to generate information, the noise generating section 211 generates random data (which may be a random scalar value, or may be a vector value in which the value of each component is set to be random) and outputs the random data to the information generating section 212.

The information generating section 212 is, as an example, a neural network subjected to machine learning so as to receive the input of the random data output by the noise generating section 211 and generate predetermined kinds of information (text data, image data, and the like). A specific configuration of the information generating section 212 may differ depending on the kind of information to be generated. An example of the information generating section 212 is a generator in a conditional generative adversarial network (CGAN) illustrated such as in M. Mizra, et al., “Conditional Generative Adversarial Nets,” arXiv preprint, arXiv: 1411.1784 (2014) or the like. Various generators corresponding to the kinds of information to be generated are already known, and therefore, these generators can be used as the information generating section 212. The information generating section 212 outputs the generated information.

In an example of the present embodiment, as illustrated in the section A in FIG. 2, the first machine learning model 21 includes a plurality of information generating sections 212. In the example here, each of the plurality of information generating sections 212 generates article information in the target state, and is subjected to machine learning so as to generate (output) each of the following pieces of information in the target state:
Article image: image data that is displayed on a Web page related to an article (which Web page will hereinafter be referred to as an article page) and represents the article
Article title: text data of an article name displayed on the article page
Article price: numerical data of a sales price of the article displayed on the article page

In the following example, it is assumed that the article information in the target state is regarded as being determined to be fraudulent article information. Needless to say, it may be assumed that the article information in the target state is regarded as being determined to be genuine article information (otherwise, the article information is fraudulent article information, and therefore, this means the same in this case).

[Second Machine Learning Model]

As illustrated in the section (B in FIG. 2, the second machine learning model 22 includes at least one discriminator 221 and a recognizing section 222. The discriminator 221 is provided in a manner corresponding to an information generating section 212 of the first machine learning model 21. In a stage of performing machine learning, the discriminator 221 receives the input of information of a predetermined modality (kind) (text data, image data, or the like) which information is output by the corresponding information generating section 212. The discriminator 221 is a neural network that is subjected to machine learning so as to output a probability that the predetermined kind of information received here, such as text data or image data, is not in the target state (is genuine, for example). The discriminator 221 may alternatively output a probability that the information is in the target state (that is, the information is fraudulent) as a complementary event thereof; however, description will be made here by taking as an example a probability that the information is not in the target state, that is, a probability that the information is genuine information. The discriminator 221 is a discriminator in the above-described CGAN. Various discriminators corresponding to various kinds of target information are widely known. Such a known discriminator may be used as the discriminator 221 in the present embodiment. Incidentally, machine learning models that discriminate among pieces of information regarding respective modalities of article information may collectively be treated as the second machine learning model 22.

In addition, at the time of inference (in a stage of determining whether information actually appearing on an article page is fraudulent or genuine), the discriminator 221 receives the input of corresponding data included in the article page, and according to a result of machine learning, the discriminator 221 outputs a probability that the received predetermined kind of information such as text data or image data is not in the target state, that is, the information is genuine in this case, in this example.

The recognizing section 222 outputs a probability that the input information is not in the target state, on the basis of the information output by the discriminator 221. In an example of the present embodiment, the recognizing section 222 may obtain a weighted average of probabilities output by a plurality of discriminators 221 with respective machine-learned weights and output the result, or the recognizing section 222 may function as a neural network and output a probability that the whole of the article page is not in the target state on the basis of the probabilities that pieces of information regarding individual modalities are not in the target state, the probabilities being output by the plurality of discriminators 221 by machine learning. Here, the recognizing section 222 may detect whether or not article information is in the target state, on the basis of a condition that a probability that the article page (corresponding to the article information) is not in the target state exceeds a predetermined threshold value or is less than the predetermined threshold value. For example, in a case where the discriminators 221 output probabilities that data related to the respective modalities is genuine, the recognizing section 222 may obtain a probability that the whole of the article page as the article information is genuine, on the basis of the probabilities that the data of the individual modalities is genuine, the probabilities being output by the plurality of discriminators 221, and may detect that the article information is fraudulent, on the basis of a condition that the probability exceeds a predetermined threshold value or is less than the predetermined threshold value.

[Machine Learning]

Here, the machine learning processing of the first and second machine learning models 21 and 22 will be described. In the following example, it is assumed that the detecting device 1 performs the machine learning processing of the first and second machine learning models 21 and 22. However, as already described, the embodiment of the present disclosure is not limited to this, and the machine learning processing may be performed in another information processing device such as a machine learning device different from the detecting device 1. The mutual learning of the first and second machine learning models 21 and 22 in the present embodiment may adopt a mode of machine learning processing of a generative adversarial network (GAN) or may adopt a mode of learning processing of a CGAN.

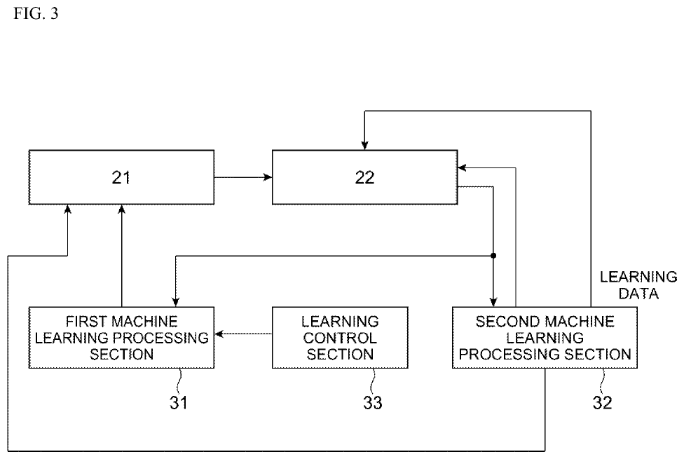

In the example here of the present embodiment, suppose that the control unit 11 executes a program for the machine learning processing stored in the storage unit 12, and that, as illustrated in FIG. 3, the control unit 11 thereby implements a configuration functionally including a first machine learning processing section 31 that performs the machine learning of the first machine learning model 21, a second machine learning processing section 32 that performs the machine learning of the second machine learning model 22, and a learning control section 33 that controls each of the machine learning processing sections.

In addition, in the machine learning processing, the machine learning of the first machine learning model 21 and the machine learning of the second machine learning model 22 are mutually performed. In the following example, for the machine learning of the second machine learning model 22, there are prepared in advance, as learning data, a plurality of sets of information including actual article images, actual article titles, and actual article prices in the past obtained when articles that were clearly in the target state or not in the target state (that is, genuine or not), for example, articles confirmed to be genuine, were exhibited or sold, for example.

Incidentally, in a certain example of the present embodiment, the information generating sections 212 included in the first machine learning model 21 may each receive the input of random data in advance, and perform preliminary machine learning on the basis of information actually in the target state (for example, genuine or fraudulent information) (the number of pieces of information may be small, and the machine learning does not need to be sufficient) so as to output information of an article image, an article title, and an article price in the target state (for example, genuine or fraudulent) as target information.

The first machine learning processing section 31 makes the noise generating section 211 of the first machine learning model 21 generate random data (corresponding to random noise or a latent variable), and makes each of the plurality of information generating sections 212 generate information of an article image in the target state (for example, a genuine or fraudulent article image), an article title in the target state (for example, a genuine or fraudulent article title), and an article price in the target state (for example, a genuine or fraudulent article price) on the basis of the random data. Here, label information (category information) may be coupled (for example, connected) to the random data input to the plurality of information generating sections 212. Here, the label information (category information) may correspond to the types of modalities of the article information and may correspond to whether or not the article information is in the target state, for example, correspond to a fraudulent type.

The first machine learning processing section 31 outputs a plurality of kinds of information obtained by the respective information generating sections 212 of the first machine learning model 21 to the discriminators 221 of the second machine learning model 22, the discriminators 221 corresponding to the respective kinds. The first machine learning processing section 31 obtains information regarding a probability that the set of information is determined to be genuine, the probability information being output by the recognizing section 222. The first machine learning processing section 31 updates parameters of the first machine learning model 21 by processing such as back propagation so as to increase a probability that the information obtained by the first machine learning model 21 is determined to be in the target state (genuine or fraudulent) (i.e., so as to decrease a loss function in which the information is determined to be in the target state).

At this time, the first machine learning processing section 31 does not change parameters (weights or the like) of the discriminators 221 and the recognizing section 222.

The first machine learning processing section 31 performs the machine learning of the first machine learning model 21 by repeatedly performing this processing of making the first machine learning model 21 generate a set of information, making the second machine learning model 22 recognize whether or not the information is in the target state (that is, whether the information is genuine or not), and updating the parameters of the first machine learning model 21 by processing such as back propagation so as to decrease the loss function in which the information is determined to be in the target state.

The second machine learning processing section 32 repeatedly performs the following processing. The second machine learning processing section 32 decides, according to a predetermined rule (for example, randomly), which of article information to be determined not to be in the target state (for example, genuine) and article information to be determined to be in the target state (for example, fraudulent) is to be output to the second machine learning model 22.

When the second machine learning processing section 32 decides here that article information not in the target state (for example, genuine article information) is to be output, the second machine learning processing section 32 reads a set of information including an actual article image, an actual article title, and an actual article price obtained in the past, which information is included in learning data prepared in advance. Then, the second machine learning processing section 32 outputs each kind of information included in the learning data prepared in advance to the discriminators 221 of the second machine learning model 22 corresponding to the respective kinds, in addition to the set of information generated by the first machine learning model 21, and obtains information regarding a probability that the information set is determined not to be in the target state (for example, genuine).

The second machine learning processing section 32 in the present example updates the parameters of the discriminators 221 and the recognizing section 222 of the second machine learning model 22 by processing such as back propagation so as to increase a probability that the second machine learning model 22 determines that the input information set is not in the target state (is, for example, genuine) (i.e., so as to decrease the loss function in which the input information set is determined to be in the target state (for example, fraudulent)).

In addition, when the second machine learning processing section 32 decides in the foregoing decision that article information in the target state (fraudulent article information) is to be output, the second machine learning processing section 32 makes the noise generating section 211 of the first machine learning model 21 generate random data, and makes each of the plurality of information generating sections 212 generate information of an article image in the target state (fraudulent article image), an article title in the target state (fraudulent article title), and an article price in the target state (fraudulent article price) on the basis of the random data.

Then, the second machine learning processing section 32 outputs the pieces of information regarding the plurality of modalities (kinds) obtained by the respective information generating sections 212 of the first machine learning model 21 to the discriminators 221 of the second machine learning model 22 corresponding to the respective modalities (kinds), and obtains information regarding a probability that the information set is determined not to be in the target state (is, for example, determined to be genuine), the probability information being output by the recognizing section 222. In this case, the second machine learning processing section 32 updates the parameters of the discriminators 221 and the recognizing section 222 of the second machine learning model 22 by processing such as back propagation so as to increase a probability that the information obtained by the first machine learning model 21 is determined to be in the target state (is, for example, determined to be fraudulent) (i.e., so as to decrease the loss function in which the information is determined to be in the target state).

In this processing of the second machine learning processing section 32, the parameters of the first machine learning model 21 are not updated. Incidentally, label information (category information) may be coupled to the data of the respective modalities of article information to be input to the plurality of discriminators 221. Here, the label information (category information) may correspond to the types of the modalities of the article information and may correspond to information relating to whether the article information is genuine or not, for example, a fraudulent type.

The learning control section 33 makes the updating of the parameters of the first machine learning model 21 by the first machine learning processing section 31 and the updating of the parameters of the second machine learning model 22 by the second machine learning processing section 32 performed alternately (either may be performed first). At this time, as for information relating to articles that are exhibited and are not in the target state (for example, genuine articles), learning data can be prepared with use of actually existing information.

[Inference Operation]

An operation of inference processing of the detecting device 1 will next be described. The detecting device 1 that performs this inference processing does not necessarily need to functionally include the first machine learning model 21. In addition, the detecting device 1 uses this inference processing to receive the input of a Web page (article page) corresponding to article information and determine whether or not the information of an article appearing on the article page is in the target state (for example, genuine or fraudulent).

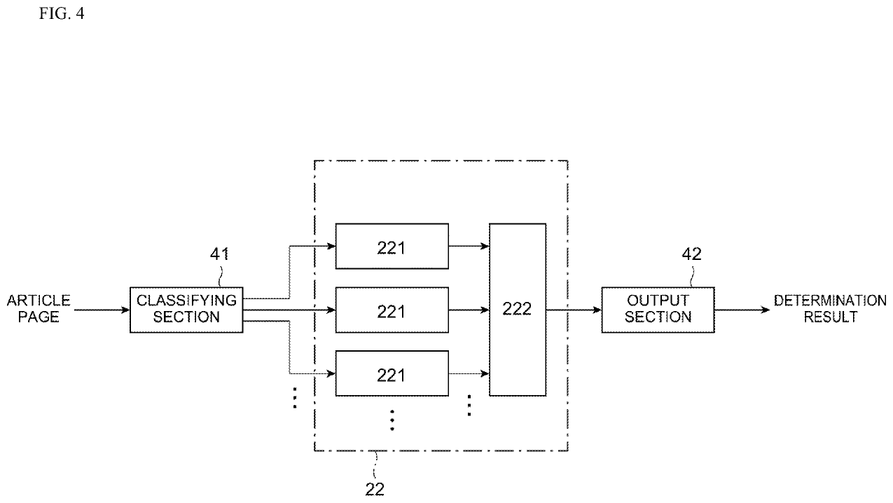

When performing this inference processing, the control unit 11 of the detecting device 1 executes a program for the inference processing stored in the storage unit 12 and thereby functionally implements a configuration including a classifying section 41, a second machine learning model 22, and an output section 42 as illustrated in FIG. 4. Here, the second machine learning model 22 adopts the same configuration as that already described, and the machine learning of the second machine learning model 22 has been performed by the second machine learning processing section 32. Repeated description of the second machine learning model 22 will therefore be omitted in the following.

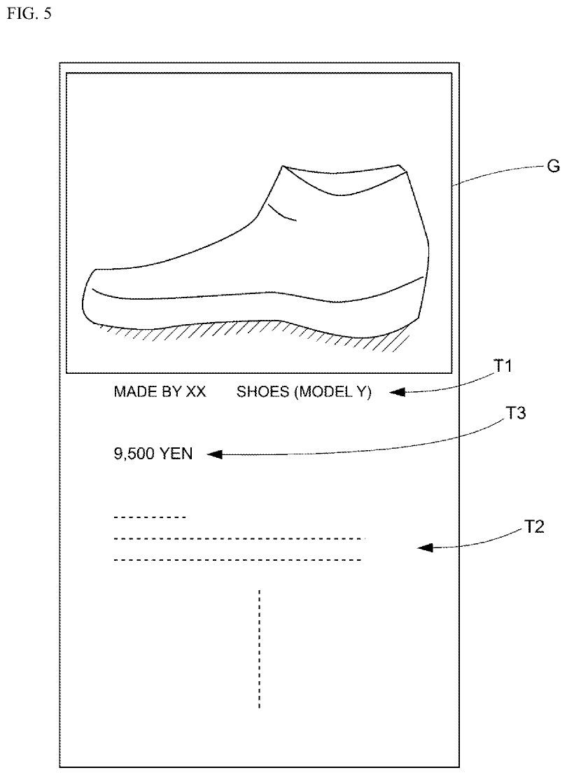

The classifying section 41 obtains the input of information of an article page as a target of recognition from the server device 2, for example. Here, the information of the article page corresponding to article information is typically described in hyper text markup language (HTML). As illustrated in FIG. 5, the information of the article page includes the following.
Article title: text data (T1) representing an article title (article name)
Article image (a uniform resource locator (URL) of an obtainment source is specified by an image (IMG) tag in HTML): image data (G)
Article description: text data (T2) representing an article descriptive sentence describing contents of the article or the like
Article price: numerical data (T3) representing the price of the article

In the following example, suppose that mutually different pieces of tag information (class information of div tags or the like) are provided to the respective kinds of data, and that the kinds of data can thus be discriminated from one another.

The classifying section 41 refers to the above-described tag information from the obtained information of the article page and extracts each piece of the text data of the following.
Article title
Article price

In addition, the classifying section 41 obtains the image data of the article image from the specified URL.

The classifying section 41 outputs the respective pieces of extracted text data and the obtained image data to the discriminators 221 of the second machine learning model 22 corresponding to the respective kinds.

Then, each of the discriminators 221 estimates and outputs a probability that the input information is not in the target state (for example, genuine). The recognizing section 222 outputs information indicating whether or not the information of the article page describes an article not in the target state (for example, a genuine article), on the basis of a weighted average of the outputs of the respective discriminators 221. As an example, the recognizing section 222 obtains a weighted average of the outputs of the respective discriminators 221 and outputs the weighted average.

When the value of the average output by the recognizing section 222 of the second machine learning model 22 exceeds a predetermined threshold value, for example, 0.5, the output section 42 outputs a recognition result indicating that the information of the article page received by the classifying section 41 is not in the target state (for example, genuine). When the average is less than the predetermined threshold value, for example, 0.5, the output section 42 outputs a recognition result indicating that the information of the article page received by the classifying section 41 is in the target state (for example, fraudulent).

### Effects of Embodiment

According to the present embodiment, the first machine learning model 21 and the second machine learning model 22 are both subjected to machine learning by mutual learning. That is, the first machine learning model 21 is subjected to machine learning so as to output, for example, fraudulent information (information not corresponding to a genuine article) such as an article title, an article image, and a price assumed to appear on an article page. In addition, the second machine learning model 22 is subjected to machine learning so as to discriminate between genuine information such as an article title and an article image appearing on an article page relating to a genuine article which has actually been exhibited and the fraudulent information generated by the first machine learning model 21.

[Another Example of First Machine Learning Model]

In the description thus far of the present embodiment, the first machine learning model 21 is assumed to be a generator in an ordinary CGAN. However, the present embodiment is not limited to this. According to another example of the present embodiment, a first machine learning model 21′ is provided for mutual learning together with the second machine learning model 22, and the first machine learning model 21′ may be an editor that receives the input of information of an article page not in the target state (for example, a genuine article page), and generates information of an article page in the target state (for example, a fraudulent article page) by editing and processing at least part of the information of the article page not in the target state.

The first machine learning model 21′ in the present example includes a plurality of information generating sections 212′ corresponding to respective kinds of information listed as follows, for example:
Article title
Article image
Article description
Article price
   and so forth.

Here, for example, the information generating section 212′ that generates the image data of the article image in the target state (for example, a fraudulent article image) can be configured by using a neural network that processes the image data of an article image not in the target state (for example, a genuine article image) actually used on an article page in the past and outputs the result.

Thus, in the first machine learning model 21′ according to the present example of the present embodiment, the information generating sections 212′ may include a machine-learnable neural network, and perform machine learning by mutual learning together with the second machine learning model 22.

Needless to say, it suffices for the information generating sections 212′ of the first machine learning model 21′ in the present example to be able to process text data and image data not in the target state (for example, genuine text data and genuine image data) actually used on an article page in the past, and to be able to perform mutual learning together with the second machine learning model 22, and the information generating sections 212′ may output a plurality of word replacement candidates, additional candidates, and the like in a rule-based manner. In this case, it suffices for the information generating sections 212′ to include a neural network or the like and to be subjected to machine learning so as to select one of the plurality of output candidates.

Incidentally, when the information generating sections 212′ receive the input of information of a genuine article page and edit and process at least part of the information in the present example, the information generating sections 212′ may adopt a mode of performing encoding of information (data) of each modality constituting the information of the article page (article information) not in the target state (for example, a genuine article page), and performing decoding after obtaining some representation such as a vector representation. A variational autoencoder (VAE), for example, may be adopted as appropriate.

[Yet Another Example of Kinds of Information]

In addition, in the description thus far, the following pieces of information are cited as examples of the kinds of information which are generated by the information generating sections 212 or 212′ of the first machine learning model 21 or 21′ and for which the discriminators 221 of the second machine learning model 22 discriminate whether or not the information is in the target state (that is, genuine or not).
Article title
Article image
Article description
Article price

However, the present embodiment is not limited to this, and the following may further be included, for example.
Article category: predetermined text data such as “ladies' clothing”
Article size: text data selected from predetermined character strings such as “size S”
Article brand: text data selected from predetermined character string candidates such as the name of a manufacturer
Article state: text data including words appearing frequently such as “new article” and “unused”
Text data such as a responsibility for a delivery charge, an estimated shipping date, and the area of a sender
Text data as information related to an exhibitor such as the number of “likes” given to an article page and an evaluation/comment given to the exhibiting user
Text data related to attributes of an exhibitor such as a profile of the exhibiting user, a service usage start date and time, and an internet protocol (IP) address Also in the case of including the above, the first machine learning model 21 or 21′ is provided with information generating sections 212 or 212′ that generate the respective kinds of information, and the second machine learning model 22 is provided with corresponding discriminators 221.

In other words, the plurality of modalities of the article information may include attribute data or text data representing the category, size, or brand of the article, may include attribute data or text data representing the state of the article (new, unused, scratched, and so forth), may include attribute data or text data representing an arrangement related to the delivery charge of the article (a purchaser or a successful bidder is responsible for the delivery charge, for example), may include attribute data, numerical data, or text data indicating a period or a timing of a shipping date of the article (shipment timing), may include attribute data or text data representing the region (area) of the sender of the article, may include numerical data representing the number of likes of the article (number of times that a social button is designated), may include attribute data representing the attributes of the exhibitor or the seller of the article, may include numerical data representing a date and time of service registration of the exhibitor or the seller of the article, may include attribute data or text data representing information corresponding to a residence region of the exhibitor or the seller of the article such as an IP address, and may include evaluation data representing results of evaluation of the exhibitor or the seller of the article at multiple levels. Further, the plurality of modalities of the article information may include movie data describing contents of the article or the like, may include audio data describing contents of the article or the like, and may include three-dimensional shape data (three-dimensional model data) representing the external appearance of the article.

[Example in which Information Generation and Recognition are Performed by Pair of Configurations]

In addition, in the examples thus far, the first machine learning model 21 or 21′ is provided with the individual information generating sections 212 or 212′ for the respective kinds of information to be generated, and also the second machine learning model 22 is provided with the individual discriminators 221 for the respective kinds of information included in the article page. However, the present embodiment is not limited to these examples.

The first machine learning model 21 or 21′ may, for example, be provided with a single information generating section 212 or 212′ that generates text data of the whole of an article page in the target state (for example, a fraudulent article page), and may generate and output the text data of the whole of the article page. In this case, the second machine learning model 22 is provided with one discriminator 221 that outputs a probability that the text data of the whole of the article page is not in the target state (is, for example, genuine). In this case, the recognizing section 222 is not necessarily required.

Also in the present example, the first machine learning model 21 or 21′ and the second machine learning model 22 are provided for the processing of mutual learning. Then, the second machine learning model 22 having been subjected to machine learning receives the input of text data of the whole of an article page and outputs a probability that the article page represented by the text data is not in the target state (is, for example, genuine). The second machine learning model 22 can therefore be provided for the processing of determining whether or not the article page is in the target state (is, for example, fraudulent).

[Example of Making Provision for Each Article Genre]

In addition, in a certain example of the present embodiment, the second machine learning model 22 to be subjected to machine learning so as to determine whether or not data included in an article page is genuine may be prepared for each genre (category) of articles.

In the present example, a set of the first machine learning model 21 or 21′ and the second machine learning model 22 is prepared for each genre of articles, and the sets are each provided for the processing of mutual learning.

Specifically, in the present example, when the second machine learning processing section 32 corresponding to a certain article genre decides here that information related to an exhibited article which is not in the target state (is, for example, genuine) is to be output, the second machine learning processing section 32 reads a set of information including an actual article image, an actual article title, and an actual article price obtained in the past which information is included in learning data prepared in advance and is related to exhibition in the corresponding article genre. Then, the second machine learning processing section 32 outputs the read kinds of information to the discriminators 221 of the second machine learning model 22 corresponding to the respective kinds. The second machine learning processing section 32 obtains information regarding a probability that the set of information is determined not to be in the target state (is, for example, determined to be genuine), the probability information being output by the recognizing section 222. As for the other processing, processing similar to that of the examples already described is performed.

Thus, the second machine learning processing section 32 determines whether or not data included in an article page in the corresponding article genre is in the target state (is, for example, fraudulent). Meanwhile, the first machine learning model 21 or 21′ to be subjected to mutual learning is subjected to machine learning so as to generate data in the target state (for example, fraudulent data) which data is close to the data that is included in an article page in the corresponding article genre and is not in the target state (for example, genuine data).

Incidentally, the first machine learning model 21′ in the present example may retain a plurality of pieces of data extracted from article pages in the corresponding article genre and use the plurality of pieces of data as reference information.

It should be understood by those skilled in the art that various modifications, combinations, sub-combinations and alterations may occur depending on design requirements and other factors insofar as they are within the scope of the appended claims or the equivalents thereof.

What is claimed is:

1. A detecting device comprising:
a second machine learning model provided for mutual learning together with a first machine learning model, the first machine learning model being subjected to machine learning so as to generate genuine or fraudulent article information having a plurality of modalities, and the second machine learning model being subjected to machine learning so as to discriminate whether article information having a plurality of modalities is genuine or not;
an obtaining section configured to obtain article information having a plurality of modalities; and
an estimating section configured to estimate whether the article information that is obtained by the obtaining section and has the plurality of modalities is genuine or not, by using the second machine learning model.

2. The detecting device according to claim 1, wherein
the first machine learning model is subjected to machine learning so as to generate fraudulent article information obtained by editing and processing at least part of genuine article information having a plurality of modalities.

3. The detecting device according to claim 1, wherein
the article information having a plurality of modalities includes image data representing an article image.

4. The detecting device according to claim 1, wherein
the article information having a plurality of modalities includes text data representing an article title.

5. The detecting device according to claim 1, wherein
the article information having a plurality of modalities includes text data representing an article descriptive sentence.

6. The detecting device according to claim 1, wherein
the article information having a plurality of modalities includes numerical data representing an article price.

7. The detecting device according to claim 1, wherein
the article information having a plurality of modalities includes attribute data representing an article category.

8. The detecting device according to claim 1, wherein
the article information having a plurality of modalities includes numerical data representing a shipment timing.

9. The detecting device according to claim 1, wherein
the article information having a plurality of modalities includes attribute data representing an attribute of an exhibitor or a seller.

10. The detecting device according to claim 1, wherein
the article information having a plurality of modalities includes numerical data representing an evaluation given to an exhibitor or a seller.

11. A detecting method executed by a computer,
the computer including a second machine learning model provided for mutual learning together with a first machine learning model, the first machine learning model being subjected to machine learning so as to generate genuine or fraudulent article information having a plurality of modalities, and the second machine learning model being subjected to machine learning so as to discriminate whether article information having a plurality of modalities is genuine or not,
the detecting method comprising:
obtaining article information having a plurality of modalities; and
estimating whether the obtained article information having the plurality of modalities is genuine or not, by using the second machine learning model.

12. A computer readable and non-transitory recording medium which stores a detecting program for a computer,
the computer storing a second machine learning model provided for mutual learning together with a first machine learning model, the first machine learning model being subjected to machine learning so as to generate genuine or fraudulent article information having a plurality of modalities, and the second machine learning model being subjected to machine learning so as to discriminate whether article information having a plurality of modalities is genuine or not,
when the detecting program is executed by the computer, the program causing the computer to function as:
an obtaining section configured to obtain article information having a plurality of modalities; and
an estimating section configured to estimate whether the article information that is obtained by the obtaining section and has the plurality of modalities is genuine or not, by using the second machine learning model.

13. A machine learning device comprising:
a learning section configured to make a first machine learning model and a second machine learning model perform mutual learning such that the first machine learning model generates genuine or fraudulent article information having a plurality of modalities and such that the second machine learning model discriminates whether article information having a plurality of modalities is genuine or not.

14. A machine learning method comprising:
making a first machine learning model and a second machine learning model perform mutual learning such that the first machine learning model generates genuine or fraudulent article information having a plurality of modalities and such that the second machine learning model discriminates whether article information having a plurality of modalities is genuine or not.

15. A machine learning model capable of discriminating whether article information having a plurality of modalities is genuine or not, the machine learning model being a second machine learning model subjected to mutual learning by a machine learning method together with a first machine learning model,
the machine learning method including
making the first machine learning model and the second machine learning model perform mutual learning such that the first machine learning model generates genuine or fraudulent article information having a plurality of modalities and such that the second machine learning model discriminates whether article information having a plurality of modalities is genuine or not.
